(19) United States
(12) Patent Application Publication
(10) Pub. No.: US 2026/0306231 A1
(43) Pub. Date: Oct. 8, 2026

(54) Dental Veneer Kit

(71) Applicant: Michael J. Morgan, Hinsdale, IL (US)

(72) Inventor: Michael J. Morgan, Hinsdale, IL (US)

(21) Appl. No.: 19/642,381

(22) Filed: Apr. 8, 2026

Related U.S. Application Data
(60) Provisional application No. 63/785,306, filed on Apr. 8, 2025.

(51) Int. Cl. A61C 19/02; A61C 13/00; A61C 13/12

(52) U.S. Cl. CPC A61C 19/02; A61C 13/0004; A61C 13/0019; A61C 13/12

(57) ABSTRACT

A dental veneer kit for providing generally everything a dentist needs to do veneers is described herein. The dental veneer kit includes one or more veneers, a solid model, isolation, ceramic primer, bonding adhesive, bonding resin, micro-brushes, polishing paste, a rubber polishing wheel and a goat hair polishing wheel. In some approaches, the one or more veneers, the solid model and all the tools and materials of the veneer kit are loaded in a box and shipped to the dentist.

### CROSS REFERENCE TO RELATED APPLICATION

This application claims benefit of U.S. Provisional Application No. 63/785,306, filed Apr. 8, 2025, which is hereby incorporated herein by reference in its entirety.

### TECHNICAL FIELD

These teachings relate generally to dental veneers and more particularly to a dental veneer kit.

### BACKGROUND

Dental veneers are thin shells designed to cover a front surface of a patient's teeth. For example, dental veneers may be used to address a variety of dental issues including discoloration, chipped or broken teeth, misalignment, and gaps between teeth. The specialized skills and instruments required to deliver dental veneers to patients may limit the number of dentists able to perform the veneer process. Therefore, a dental veneer kit that may expand a dentist's offerings may be desirable.

### BRIEF DESCRIPTION OF DRAWINGS

Various needs are at least partially met through provision of the dental veneer kit described in the following detailed description, particularly when studied in conjunction with the drawings. A full and enabling disclosure of the aspects of the present description, including the best mode thereof, directed to one of ordinary skill in the art, is set forth in the specification, which refers to the appended figures, in which:

FIG. 1 is an image of a dental veneer kit in accordance with various embodiments of these teachings;

FIG. 2 is an image of the dental veneer kit of FIG. 1;

FIG. 3 is an image of the dental veneer kit of FIG. 1;

FIG. 4 is an image of the dental veneer kit of FIG. 1;

FIG. 5 is an image of the bonding adhesive kit of FIG. 4;

FIG. 6 is an image of the dental veneer kit of FIG. 1; and

FIG. 7 is a flow diagram of a process for providing a dental veneer kit to a dentist.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Traditionally, the process of applying dental veneers involves multiples steps and can require a dentist to source various tools and materials separately from various manufacturers. This can lead to inefficiencies, increased costs, and potential inconsistencies in the application process. For example, a dentist may typically use multiple suppliers to obtain the necessary components, which can result in increased costs, delays, and complications. Moreover, many dentists do not perform enough veneer procedures to have all the tools and materials required for the veneer procedures. This limitation can restrict the services the dentist offers and prevent the dentist from expanding their practice without significant investment in additional tools and equipment.

Accordingly, the dental veneer kit described herein provides dentists with a comprehensive solution to greatly expand the services offered without the significant investment in all the additional tools and equipment. The dental veneer kit is a complete kit, ready for application which allows the dentist to deliver veneers efficiently to the patient, and ensure consistent, high-quality results.

Generally speaking, the various aspects of the present disclosures relate to a dental veneer kit for a veneer procedure that includes generally all the necessary components for the dentist to prepare, apply, and finish the veneers. In particular, the dental veneer kit includes one or more veneers, a solid model, and generally the tools and materials the dentist needs for the veneer procedure including a case with the veneers placed therein, isolation, ceramic primer, bonding adhesive, bonding resin, micro-brushes, polishing paste, and polishing tools.

The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

The foregoing and other benefits may become clearer upon making a thorough review and study of the following detailed description.

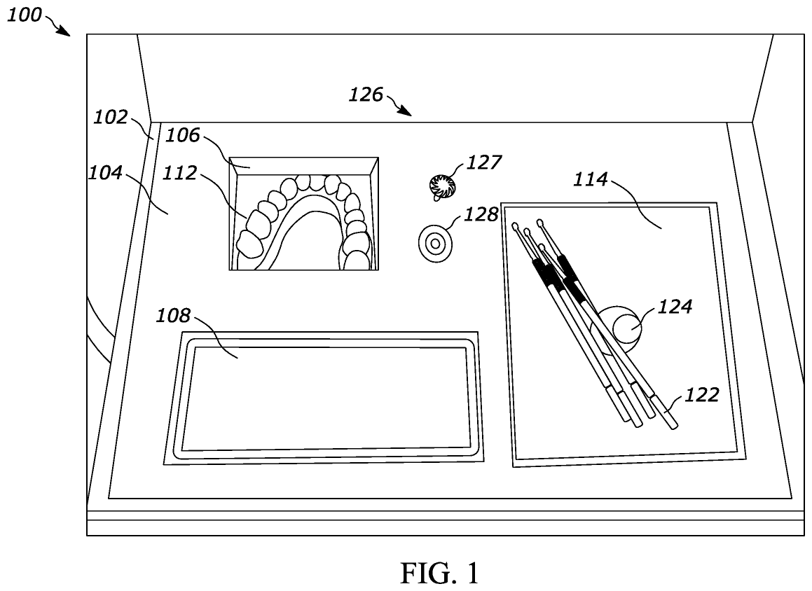

Referring now to the drawings, and in particular to FIG. 1, a dental veneer kit 100 in accordance with various embodiments is shown. The dental veneer kit 100 includes a case 108 with the veneers 110 placed therein, a solid model 112, isolation 114, a ceramic primer 116, a bonding adhesive 118, a bonding resin 120, micro-brushes 122, polishing paste 124, and polishing tools 126. In one example, the polishing tools 126 include a rubber polishing wheel 127 and a goat hair polishing wheel 128.

The dental veneer kit 100 is a complete, ready-to-use kit for a veneer procedure that includes generally the necessary components a dentist, also referred to as a practitioner, may need for the preparation, application, and finishing of the veneers 110. More specifically, the dental veneer kit 100 includes the necessary components to prepare for the veneer procedure through the use of the solid model 112, to apply the veneers 110 through the use of isolation 114, ceramic primer 116, bonding adhesive 118, bonding resin 120, and micro-brushes 122, and to finish the veneer procedure through the use of the polishing paste 124, rubber polishing wheel 126, and/or goat hair polishing wheel 128. Thus, the complete dental veneer kit 100 ensures that the dentist has generally everything required (except for certain tools that every dentist will normally have such as a dental mirror, explorer, spatula, etc. and materials such as phosphoric acid etch) to efficiently and effectively to deliver the veneers 110 to the patient, without having to purchase additional tools and/or materials.

The box 102 includes a support member 104, such as a foam insert, with a plurality of cutouts 106 formed therein to hold the items of the dental veneer kit 100, as well as provide protection and stability for the items during transit. All the above items are arranged in the box 102 in an orderly fashion for the convenience of the dentist. It is contemplated that the items may be arranged within the box 102 in any suitable manner.

In some embodiments, the dental veneer kit 100 may be ordered by the dentist, and generally everything needed for the veneer procedure is loaded in the box 102 and shipped to the dentist. The dentist may receive the dental veneer kit 100, open the box 102, and have generally all the tools, applicators, and/or materials that are needed for the veneer procedure, without having to purchase additional tools and/or materials as described above.

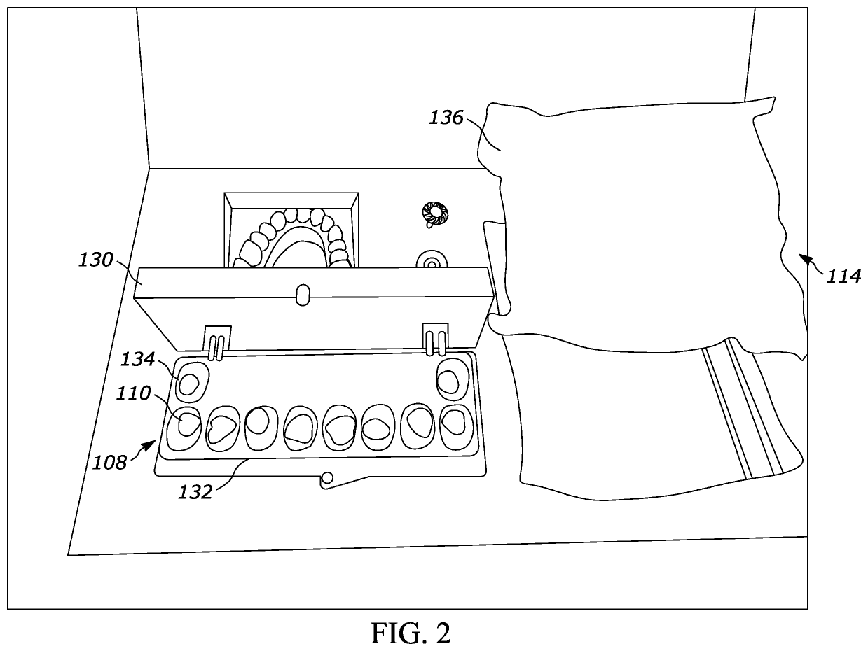

FIG. 2 shows the case 108 with the veneers 110 placed therein, and the isolation 114 of the dental veneer kit 100 of FIG. 1. The case 108 includes a cover 130 and a base 132 hingedly coupled to each other to enable opening and closing of the cover 130 relative to the base 132. The base 132 includes dividers 134 that define a recessed portion in the base 132 to allow the veneers 110 to be individually placed and secured in the case 108. The case 108 may be formed of any suitable material. The case 108 may be formed of a material that is substantially opaque to prevent exposure of the veneers 110 to light. For example, the case 108 may be formed of a light-proof plastic. In some examples, the case 108 is formed of a material that is capable of being autoclaved or otherwise sterilized.

The veneers 110 are composite dental veneers that are custom-made and fabricated using three-dimensional (3D) printing technology. The veneers 110 are designed and fabricated using, in part, dental scan data from the patient. The dental scan data of the patient may be acquired by the dentist prior to the veneer procedure using any suitable technique. The use of 3D printing technology allows for fabrication of stronger and more durable veneers, with greater efficiency and speed, compared to veneers produced through freehand methods.

In some embodiments, the dentist may upload the dental scan data via a secure platform. For example, the platform may be provided to the dentist through a web-based application or software platform, such as a secure communication portal, that can be accessed via a secure login. The secure communication portal may be hosted on one or more servers and may be accessible to a practitioner via an authenticated login. The secure communication portal allows the practitioner to upload dental scan data and related information, and to receive and review a digital veneer design. The dental scan data may be uploaded to the platform as, for example, STL files, OBJ files, or PYL files. In some embodiments, the dental scan data includes digital impressions, digital photography and patient specifications. For example, a digital impression system (e.g., a dental CAD/CAM system) may be used to acquire the dental scan data. The dental impression system may include a scanner, such as a handheld wand or intraoral scanner, to capture images (e.g., as video or a plurality of single images) of a quadrant of teeth, or a collection of teeth including opposing upper and lower arches, as well as soft tissue or other relevant intraoral structures. The captured images are processed and stitched together to form a 3D model (e.g., the dental scan data) of the dental structure of the patient. After the dental scan data is acquired, one or more modeling operations may be performed using the 3D model to digitally design the veneers and create output files (e.g., toolpaths and STL files) suitable for use by the 3D printing technology to print the veneers 110. The one or modeling operations may be performed using, for example, computer-aided (CAD) and computer-aided manufacturing (CAM) software. Thus, the dental veneer kit 100 provides veneers 110 that are fully customizable to match patient dental structure, anatomy, and esthetic requirements.

The isolation 114 includes any suitable isolation tool to provide access and visibility to the patient's mouth. As shown in FIG. 2, the isolation 114 is enclosed in a heat-sealed plastic packaging 136. In some aspects, the isolation 114 may include a cheek retractor or a rubber dam. An example of commercially available isolation includes Optragate (Ivoclar), and Isolite (Zyris). In some aspects, the isolation 114 may be chosen based on the dental scan data. For example, the dental scan data may be used to determine an appropriate size of the isolation, and the determined isolation may be subsequently loaded in the dental veneer kit 100.

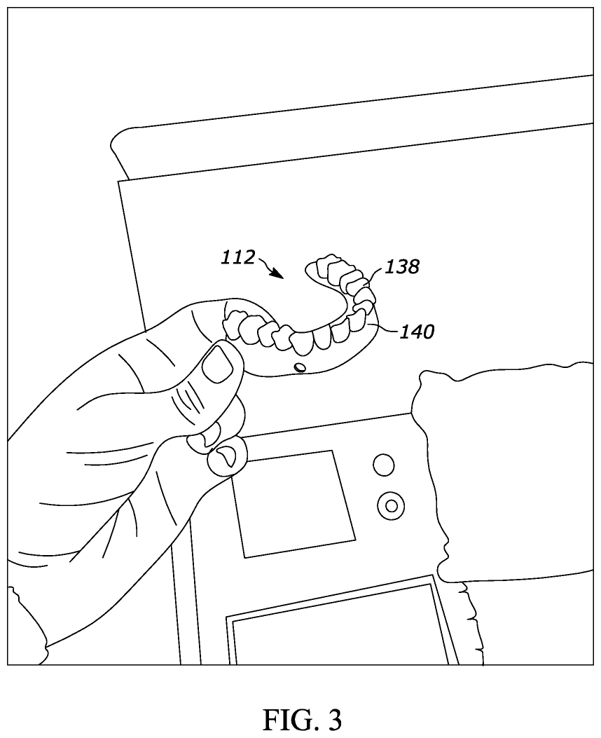

FIG. 3 shows an exemplary solid model 112 of the dental veneer kit 100 of FIG. 1. The solid model 112 is a three-dimensional (3D) printed model of the dental structure of the patient that is custom made using, in part, the dental scan data. The dental scan data may be acquired using any suitable technique as described above. In addition, the solid model 112 may be printed using any suitable 3D printing technique including, but not limited to, 3D printing, and the like. The solid model 112 may be a 3D model of a quadrant of teeth, or a collection of teeth 138 including opposing upper and lower arches, as well the gums 140 or other relevant intraoral structures. In this manner, the solid model 112 allows the dentist to try on the veneers 110 and make any suitable adjustments (e.g., reshaping, polishing, etc.) to the veneers 110 prior to bonding the veneers 110 to the teeth of the patient.

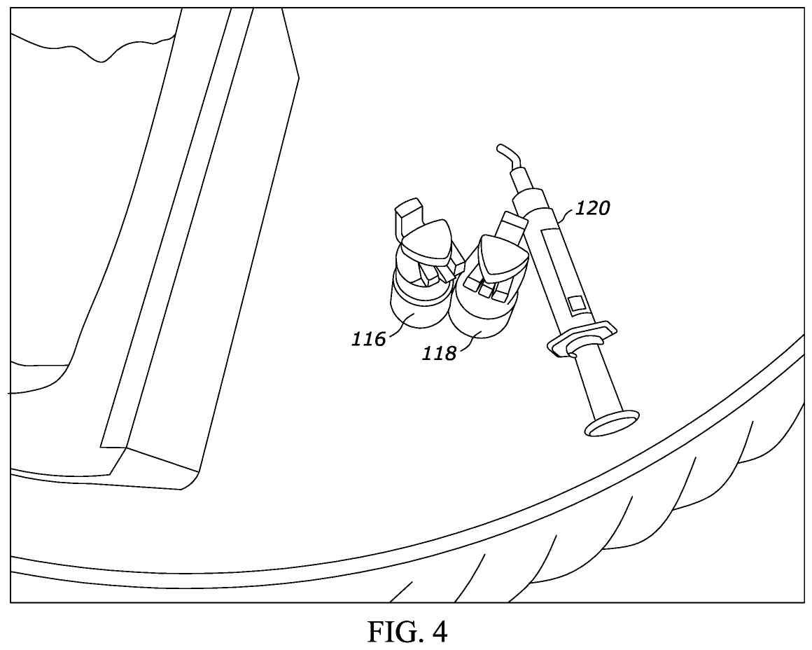

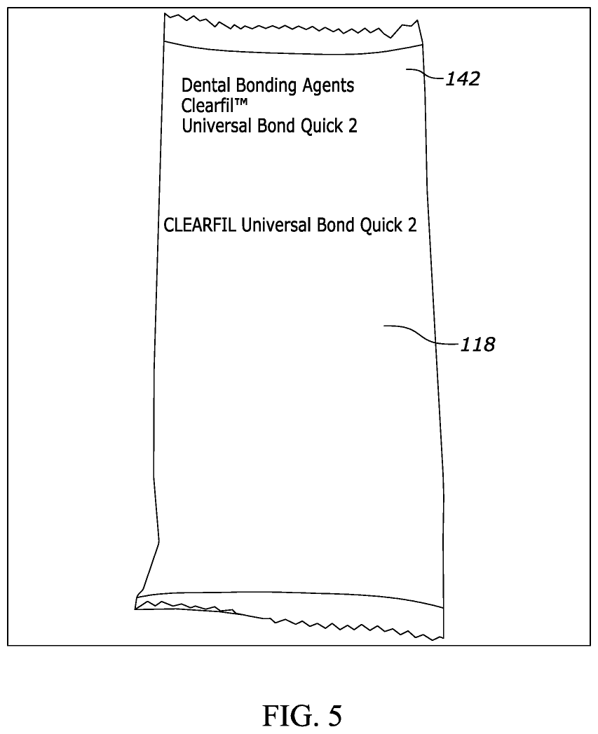

FIGS. 4 and 5 show an example of the ceramic primer 116, the bonding adhesive 118 and the bonding resin 120 of the dental veneer kit 100 of FIG. 1. The ceramic primer 116 includes any suitable ceramic primer for treating an inner surface of the veneers 110. An example of a commercially available ceramic primer includes Clearfil Ceramic Primer Plus (Kuraray Noritake Dental Inc.). The bonding adhesive 118 includes any suitable bonding adhesive for bonding the veneers 110 to the patients teeth. In some aspects, as shown in FIG. 5, the bonding adhesive 118 is enclosed in a heat-sealed plastic packaging 142. The bonding agent may be supplied in a multidose reusable bottle or a single dose disposable package. An example of a commercially available bonding adhesive includes Clearfil Universal Bond Quick 2 (Kuraray Noritake Dental Inc.). The bonding resin 120 includes any suitable bonding resin for bonding (e.g., cementing) the veneers 110 to the patients teeth.

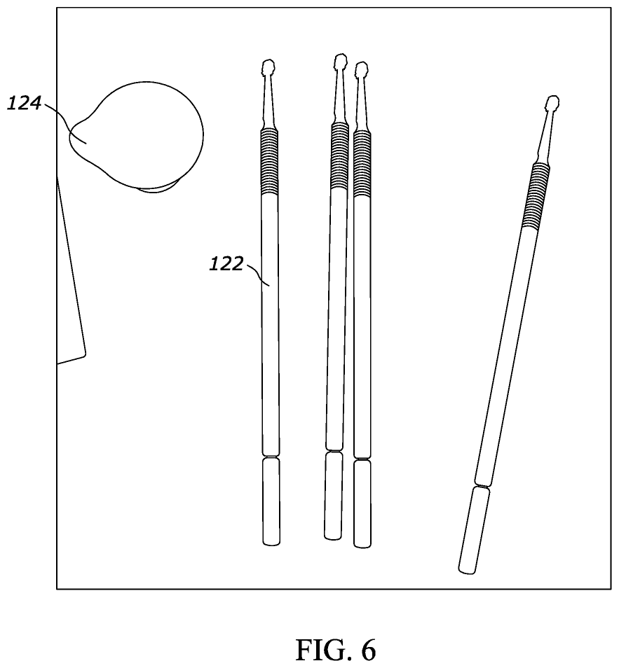

FIG. 6 shows one example of the micro-brushes 122 and the polishing paste 124 of the dental veneer kit 100 of FIG. 1. The micro-brushes 122 includes any suitable micro-brush for applying the ceramic primer 116, bonding adhesive 118, and the bonding resin 120 when preparing and treating the patients teeth and veneers 110. It is contemplated that while four micro-brushes are shown in FIG. 1, any suitable number of micro-brushes 122 may be included in the dental veneer kit 100.

The polishing paste 124 includes any suitable polishing paste to remove minor imperfections, scratches, and rough spots on surfaces of the veneers 110. The polishing paste 124 may be used by the dentist in conjunction with the polishing tools 126. In some examples, the polishing tools 126 include a rubber polishing wheel 127 and/or the goat hair polishing wheel 128 to achieve a smooth, glossy finished on the veneers 110 after the veneers 110 have been applied to the patients teeth.

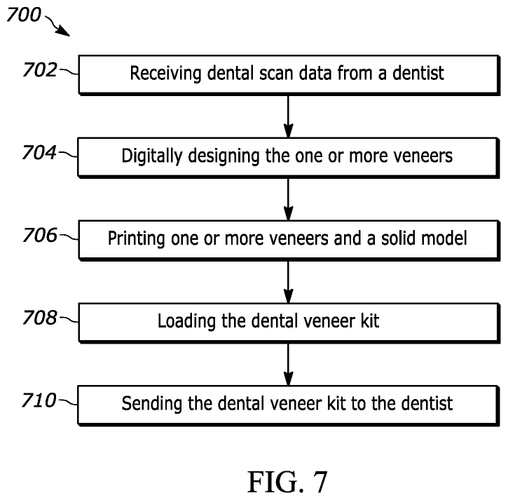

Referring now to FIG. 7, an example process 700 for providing a dental veneer kit to a dentist is shown. The process 700 includes, at step 702, receiving dental scan data from the dentist. In some embodiments, the dentist may upload the dental scan data via a secure platform. For example, the platform may be provided to the dentist through a web-based application or software platform that can be accessed via a secure or authenticated login. The platform may allow for upload and transmission of digital impressions, digital photography, and patient specifications which may be uploaded as STL files, OBJ files, and/or PLY files.

At step 704, one or more veneers are digitally designed based on the dental scan data. The digitally designed veneers include a digital mock-up or digital representation of the veneer design. In some embodiments, the digitally designed veneers are provided (i.e., uploaded and transmitted via the secure communication portal) to the dentist for approval before printing the one or more veneers at step 706.

At step 706, one or more veneers and a solid model of the patients teeth are printed based on the dental scan data. More specifically, custom designed veneers and the solid model are fabricated and printed based on the digitally designed veneers at step 704. In some embodiments, the one or more veneers and the solid model may be printed using 3D printing technology. In some embodiments, the one or more veneers and the solid model are printed after approval of the digitally designed veneers by the dentist.

At step 708, the dental veneer kit is loaded with the one or more veneers, the solid model, and generally all the tools and materials the dentist needs for the veneer procedure including a case with the veneers placed therein, isolation, ceramic primer, bonding adhesive, bonding resin, micro-brushes, polishing paste, and polishing tools such as a rubber polishing wheel and a goat hair polishing wheel. In some embodiments, the one or more veneers, the solid model and all the tools and materials of the veneer kit are loaded in a shipping container or a box to be shipped to the dentist. More specifically, the container may include a base having a plurality of dividers defining individual recessed portions and respective ones of the one or more custom veneers and the plurality of components may be placed within individual recessed portions within the container for secure transport.

At step 710, the dental veneer kit is sent to the dentist. The dentist may receive the dental veneer kit, open the box, and have generally all the tools, and materials that are needed for the veneer procedure, without having to purchase additional tools and/or materials as described above. Thus, the dental veneer kit may expand the dentist's offerings without the dentist having to invest in all of the additional tools and materials.

One of ordinary skill in dentistry would understand that certain substitutions of any of the above components can be made as long as the corresponding function in applying the veneers is available. For instance, while the illustrated embodiment shows plastic and goat hair polishing wheels, other polishing implements could be included in the kit in addition to or instead of the illustrated polishing wheels.

What is claimed is:

1. A method for providing a dental veneer kit to a practitioner for performing a veneer procedure on a patient, the method comprising:
receiving, via a secure communication portal, dental scan data of the patient uploaded to the communication portal by the practitioner, the dental scan data comprising digital files representing a dental structure of the patient;
uploading a generated digital veneer design comprising a digital representation of one or more customer veneers based on the dental scan data to the secure communication portal;
receiving, through the secure communication portal, an approval of the digital veneer design from the practitioner;
fabricating, in response to transmission of the approval of the digital veneer design via the secure communication portal, one or more patient-specific veneers;
assembling the dental veneer kit by loading the one or more patient-specific veneers, a solid model, and a plurality of components for performing the veneer procedure into a container; and
shipping the assembled dental veneer kit to the practitioner.

2. The method of claim 1, wherein the digital files comprise STL files, OBJ files, and PLY files.

3. The method of claim 1, wherein the secure communication portal is hosted on a server that is accessible to the practitioner via an authenticated login.

4. The method of claim 1, wherein the patient-specific dental scan data further comprises at least one of digital photography of the patient and patient-specific treatment specifications.

5. The method of claim 1, further comprising: generating the digital veneer design based on the patient-specific dental scan data.

6. The method of claim 5, wherein generating the digital veneer design comprises processing the patient-specific dental scan data with computer-aided design and computer-aided manufacturing software.

7. The method of claim 1, wherein fabricating the one or more patient-specific veneers comprises:
three-dimensional printing of the patient-specific veneers and the solid model based on the approved digital veneer design.

8. The method of claim 7, wherein the solid model includes a three-dimensional representation of opposing upper and lower dental arches of the patient.

9. The method of claim 1, wherein the plurality of components comprise an isolation tool, a ceramic primer, a bonding adhesive, a bonding resin, micro-brushes, a polishing paste, and at least one polishing tool.

10. The method of claim 9, wherein the at least one polishing tool includes a rubber polishing wheel and a goat hair polishing wheel.

11. The method of claim 9, wherein the plurality of components comprises all the tools and materials for the practitioner to prepare, apply, and finish the veneers on the patient.

12. The method of claim 1, wherein the dental veneer kit includes a container having a plurality of dividers defining individual recessed portions, and wherein assembling the dental veneer kit further comprises placing respective ones of the one or more custom veneers and the plurality of components in each individual recessed region.

13. The method of claim 1, wherein at least one of the plurality of components comprises an isolation tool, the method further comprising:
selecting an isolation tool based on the dental scan data; and
assembling the dental veneer kit with the selected isolation tool.

14. The method of claim 1, wherein the one or more patient-specific veneers comprise composite dental veneers.

15. A dental veneer kit comprising:
a case comprising a base and a cover, the base including a plurality of dividers defining individual recessed portions;
one or more patient-specific veneers configured to be placed in respective ones of the recessed portions;
a plurality of components configured for preparing, applying, and finishing the one or more patient-specific veneers on a patient, the plurality of components comprising a solid model, an isolation tool, a ceramic primer, a bonding adhesive, a bonding resin, one or more micro-brushes, a polishing paste, and at least one polishing tool;
wherein the case, the one or more patient-specific veneers, the solid model, and the plurality of components are configured and arranged together as a complete kit for performing a veneer procedure on the patient.

16. The dental veneer kit of claim 15, wherein the case further comprises a plurality of dividers defining individual recessed portions configured to receive one or more patient-specific veneers, a solid model, or respective ones of a plurality of components to prepare, apply, and finish the patient-specific veneers on the patient.

17. The dental veneer kit of claim 15, wherein the one or more patient-specific veneers are fabricated based on a digital veneer design of a patient-specific dental scan data.

18. The dental veneer kit of claim 15, wherein the plurality of components comprises all the tools and materials for a practitioner to prepare, apply, and finish the veneers on the patient.

19. The dental veneer kit of claim 15, wherein the one or more patient-specific veneers comprise composite dental veneers.

20. The dental veneer kit of claim 15, wherein the at least one polishing tool includes a rubber polishing wheel and a goat hair.
